(19) United States
(12) Patent Application Publication
(10) Pub. No.: US 2011/0015995 A1
(43) Pub. Date: Jan. 20, 2011

(54) Method and System for Digital Media Distribution

(76) Inventors: Scott Ellingboe, Excelsior, MN (US); Neal Kraemer, Apple Valley, MN (US); James Ludlow, St. Louis Park, MN (US); Matthew Bower, Golden Valley, MN (US)

Correspondence Address: JOHN ALEXANDER GALBREATH, 2516 CHESTNUT WOODS CT, REISTERSTOWN, MD, 21136, US

(21) Appl. No.: 12/505,235

(22) Filed: Jul. 17, 2009

(51) Int. Cl. G06Q 30/00; G06F 15/16; G06F 17/00

(52) U.S. Cl. 705/14.49; 709/206; 715/205; 709/204

(57) ABSTRACT

A process and system that facilitates electronic distribution of publications to consumers is disclosed. The inventive process and system allows the publication owner's distributor/agent to distribute the publication to the distributor/agent's prospects, clients, or associates, and customizes the publication with the name and contact information of the distributor/agent. Customized advertisements containing the distributor/agent's information can also be created within the publication.

### CROSS-REFERENCES TO RELATED APPLICATIONS

None.

### BACKGROUND

1. Field of the Invention

The present invention relates to processes and systems for distributing digital media, and also to online advertising.

2. Description of the Related Art

Online advertising and distribution of digital media is known in the art. Typically in the prior art, online advertising is customized based on what is known about the viewer's profile and preferences.

For example, U.S. Pat. No. 5,933,811 to Angles discloses a system and method for delivering customized advertisements within interactive communications systems. In Angles, the customized ads are integrated with offerings from various digital content providers—i.e., the ad is inserted as a page within the digital content. However, the ads are customized based on the profile/preferences of the viewer—i.e., the ad is not customized by inserting advertiser information into an ad template, as in the invention. In addition, email is not used as an ad delivery device.

U.S. Pat. No. 6,460,036 to Herz discloses a system and method for providing customized electronic newspapers and target advertisements. This patent is similar to Angles, in that customized advertisements are delivered to a viewer. Herz goes further, by also customizing the content that contains the advertisement. However, as with Angles, the customization is based on viewer profiles/preferences, and not by inserting advertiser information into an ad template. In addition, email is not used to deliver the customized content and advertisement.

U.S. Pat. No. 6,973,621 to Sie discloses a method for customization in a content distribution system. However, in Sie the customization involves the content itself, not advertisements contained within the content. Specifically, the content of a video service (distribution of movies, etc.) is what is customized, and it is customized based on viewer profiles. In addition, as with Angles, email is not used to deliver the content.

U.S. Pat. No. 7,341,183 to Richardson discloses a system and method for distributing media. However, Richardson focuses on distribution of event tickets and not customized advertisements per se. In addition, in this patent an identification code is emailed to the user of the system, and the user accesses the media by using the code. Richardson's system and method are significantly different from the invention, because Richardson employs an emailed identification code which is quite different from the invention's emailed link to a unique URL.

U.S. Pat. No. 7,296,026 to Patrick discloses a method and apparatus for automatically performing an online content distribution campaign. In this patent, online content is automatically customized for the viewer, based on a pre-assigned “state” of the viewer. One such “state” would be whether the viewer is likely to respond favorably to an advertisement. However, Patrick does not involve the customization of a template advertisement with an advertiser's information, as in the invention. Patrick also does not discuss an emailed link to a unique URL containing media and a customized advertisement.

U.S. Pat. No. 7,249,059 to Dean discloses an internet advertising system and method, wherein a third party professional can create and display advertisements on websites owned by entities other than the advertiser or the third party professional. The ads are customized, but the customization is based on each website's presentation rules rather than the advertiser's information. Also, in Dean, email is only used as a way to confirm a purchase, not as a way to give access to media or advertisements as in the invention.

U.S. Pat. No. 6,931,591 to Brown discloses a publishing layout wizard, which allows for customization of publications by populating templates. Email is used to deliver a special URL at which the customized advertisement can be viewed. However, in Brown this email is sent to the person doing the customization so this person can know whether the customized ad is approved for display. This is significantly different than sending a specialized URL to a prospect or client of the person seeking the customization, as in the invention, so that the prospect or client can view a customized publication containing the ad.

U.S. Pat. No. 6,574,606 to Bell discloses a method and system for cross-marketing products and services over a distributed communication network, and U.S. Pat. No. 6,101,485 to Fortenberry discloses a method for electronic solicitations for internet commerce. These patents involve the use of links—Fortenberry discusses a customer-activatable link, contained in an email, back to a specific web page; and Bell discusses links to a merchant loyalty service website. However, neither of these patents discuss customizing an ad by plugging an advertiser's information into an ad template, as in the invention.

U.S. Pat. No. 6,442,577 to Britton discloses a method and apparatus for dynamically forming customized web pages for web sites. However, this customization does not involve online publications and the advertisements contained within them, as in the invention. Further, email is not mentioned anywhere in Britton.

In sum, the prior art does not disclose or suggest a model where the ad is customized based not on the viewer's characteristics but rather the advertiser's, the ad is accessed via an emailed link to a unique URL containing the digital media and customized ad, and a third party (agent) initiates the sending of the email to the third party's prospect/client.

### SUMMARY OF THE INVENTION

The invention is a process and system that facilitates electronic distribution of publications to consumers. The inventive process and system allows the publication owner's distributor/agent to distribute the publication to the distributor/agent's prospects or clients, and customizes the publication with the name and contact information of the distributor/agent. Customized advertisements containing the distributor/agent's information can also be created within the publication. The customized digital publication starts with template pages that have substitution fields that determine where custom content will be inserted. The digital publication resides on a server that houses a Content Management System (CMS) on which the distributor/agent maintains an account. When logged into this account, the distributor/agent can select a template publication from a list of publications available to him/her and generate a custom Uniform Resource Locator (URL) for that publication. When a recipient of the custom URL receives it (via email, web link, etc.) and clicks on the link, a web page opens up with a link to the customized publication. The inventive process and system automatically pulls information from the distributor/agent's account and substitutes it into the digital publication.

Getting targeted media into the hands of a consumer is difficult and expensive. Consider all the different ways the magazine industry distributes—Publishers Clearinghouse, kid's school or sports programs as fundraisers, and advertising to name a few. All these markets have different types of service providers and product manufacturers or distributors, which advertise in various media by targeting a specific market niche. Many of these markets have small businesses/middlemen (agents) that add value to the purchase of these products and services and target the same market on a local or regional level. Because national advertising is expensive and the benefit dissipates the further the audience is from the agent's region/locality, these agents are unable or unwilling to advertise in the targeted media designed to reach a national market even though they might like to be present in a prestigious mass market publication. These agents represent an additional marketing opportunity for the advertiser to reach the target market.

The invention co-opts these agents—i.e., gives them an incentive to distribute the digital media/publication by giving them a free ad page in the publication. The ad page is a template page within the publication that contains placeholders for the agent's photo, logo, contact information and other custom information. After logging into the Content Management System, the agent sends out an email or other electronic communication to his/her prospects or clients. The other electronic communications via which the URL/link can be sent (i.e., delivery mechanisms) can include, by way of non-limiting example, a website/webpage, a text message or instant message such as those done on the Twitter system, and a communication facilitated by a social networking site such as Facebook or MySpace. The electronic communication contains a URL/link to the digital publication that resides on the Content Management System's server. The URL/link contains special coding that, when clicked on, delivers a custom digital publication to the prospect/client that includes the agent's name, contact information, etc. and/or an advertisement for the agent.

In addition to the application discussed above where the distributor is an agent distributing the publication to its clients or prospects, the inventive process and system can also be used in a consumer-to-consumer application wherein the distributor is a consumer who sends the URL/link to another consumer who is an associate of the distributing consumer, who belongs to the social or personal network of the distributing consumer, or who is otherwise associated with the distributing consumer.

Broadly speaking, the person receiving the URL/link is a consumer of the customized publication, and this receiving consumer can be a prospect, client, or associate of the person distributing the URL/link and thus the customized publication.

It is therefore an object of the present invention to provide a method for increasing distribution of digital publications, which works by incentivizing third parties to distribute the digital publications to their prospects, clients, or associates in return for customized pages or advertisements in the digital publication.

It is a further object of the invention to provide a system for practicing this method, said system communicating with computers used by distributors/agents and computers used by prospects, clients, or associates of the distributors/agents over any suitable network including the Internet.

Further objects and advantages of the invention will become apparent from a consideration of the ensuing description and drawings.

### DESCRIPTION OF THE DRAWINGS

FIG. 1 is a diagram illustrating the steps in the inventive process.

FIG. 2 shows a custom Uniform Resource Locator (URL) generated by the process.

FIG. 3 shows a digital publication template that can be customized with distributor/agent information.

FIG. 4 shows an email sent by the distributor/agent, via the inventive process and system, to the prospect or client.

FIG. 5 shows a publication launch webpage, which the prospect or client is taken to after clicking on the “View Magazine” link in the email shown in FIG. 4.

FIG. 6 shows the customized publication “cover page” that the prospect or client is taken to after clicking on the “View Current Issue” link on the publication launch webpage shown in FIG. 5.

FIG. 7 shows another customized page within the publication.

FIG. 8 is a diagram illustrating the various system components present in the invention.

### DETAILED DESCRIPTION OF THE INVENTION

The following provides a list of the reference characters used in the drawings:

10. Log-in step

20. Template selection step

30. Publication template upload step

40. Custom URL generation step

50. Custom URL delivery step

60. Publication opening step

70. Customization data pulling step

80. Custom publication delivery step

90. Domain component

100. Publication component

110. Distributor/agent component

120. Digital publication template

130. Distributor/agent field

140. Contact name field

150. Telephone number field

160. Email address field

170. Email

180. Customized email field

190. View magazine link

200. Publication launch webpage

210. Customized launch webpage field

220. View current issue link

230. Publication cover page

240. Page selection tools

250. Customized cover page field

260. Advertisement

270. Customized advertisement fields

280. Distributor/agent computer

290. System computer/server

300. Content Management System

310. Digital publication templates

320. Consumer computer

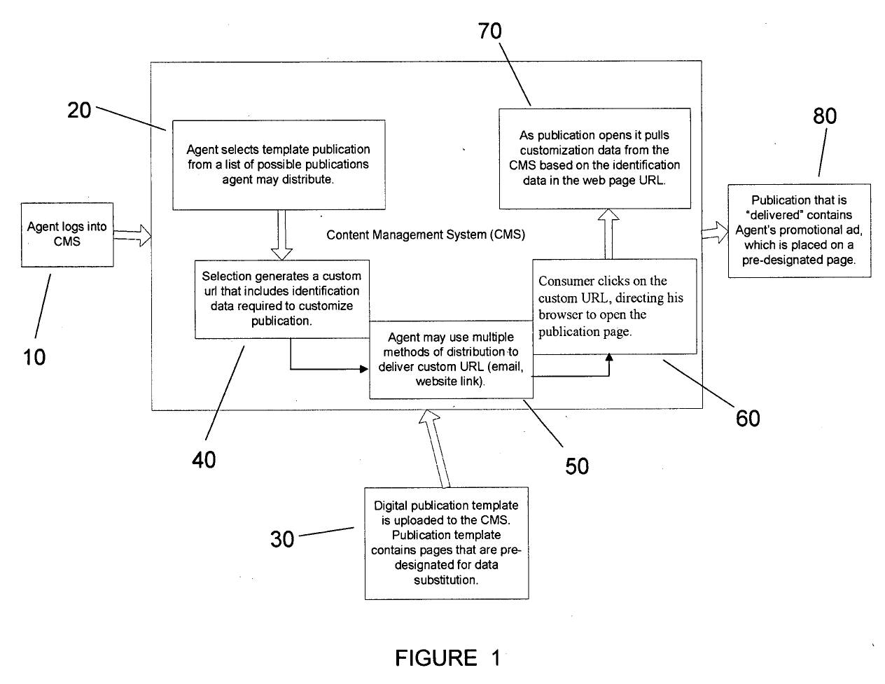

FIG. 1 illustrates the steps in the inventive process. The process begins when a distributor/agent accesses the core system of the invention, the Content Management System, in log-in step 10. The agent connects to the Content Management System via any suitable type of network, including but not limited to the Internet. Once logged on, the distributor/agent's profile is used by the inventive process and system to insert customized material into the digital publication—or said another way, the process and system inserts the customized material based on the profile of whoever is logged into the Content Management System. In template selection step 20, the agent picks a publication template (i.e., a digital publication in which the agent wishes to have a customized advertisement) from a list of possible digital publications that the agent can distribute. It should be understood that the agent can select a single publication template, or multiple publication templates. At least one of these digital publication templates, and preferably multiple templates, have previously been uploaded in publication template upload step 30 to the Content Management System from another area of the computer/server where the Content Management System resides, or from another computer connected to the computer/server where the Content Management System resides. Each publication template contains pages that are pre-designated as customizable pages into which data such as agent name, contact information, etc. can be substituted, or, pre-designated page positions within the publication into which an entirely new page can be inserted according to the wishes or needs of the distributor/agent.

In this last embodiment, wherein an entirely new page is inserted into the digital publication, the distributor/agent can determine more than just which information about them will be shown to the consumer receiving the customized publication. Instead, the distributor/agent can select pictures, graphics, text, video and audio content, etc. that will also be shown on the entirely new page in addition to information about the distributor/agent. Thus in this embodiment, the distributor/agent customizes more of the page than just the sections with the distributor/agent's information.

The invention includes an alternative embodiment wherein the agent does not play a role in the customization of the digital publication, but instead just selects a particular publication or publications from a list of possible publications the agent may distribute—without knowing exactly what the customization will entail.

In custom URL generation step 40, the Content Management System generates a custom Uniform Resource Locator (URL). The custom URL contains information identifying the publication selected by the agent in template selection step 20, as well as information identifying the agent. Next, the agent makes the custom URL available to his prospect or client (who for example can be a consumer who views the publication) in custom URL delivery step 50. The custom URL can be delivered via any suitable method, including providing a link to the URL in an email sent to the prospect or client, or providing a link to the URL on a webpage accessible to the prospect or client.

When the prospect or client clicks on the custom URL/link in publication opening step 60, that action directs the prospect or client's browser to open a publication launch webpage that contains text customized to the particular agent who distributed the custom URL, as well as a link to the customized publication itself. A cookie is also issued to the prospect or client at this point. When the prospect or client clicks on the link in the publication launch webpage, that action opens the custom publication. As the publication launch webpage and then the custom publication open, customization data is extracted from the Content Management System in customization data pulling step 70, based on the identification data contained in the custom URL—i.e., based on the particular publication and the particular agent identified in the custom URL. In other words, the custom publication is generated after the prospect or client clicks on the custom URL.

Alternatively, the publication launch webpage can be omitted, and the custom publication can open directly after the prospect or client clicks on the custom URL/link in the email sent to the prospect or client, or the custom URL/link on a webpage accessible to the prospect or client.

The specific tasks performed by the invention in customization data pulling step 70 follow:

In this example, the agent is Carrousel Travel, which has an agent ID of “9132180.” The agent ID is part of the custom URL, as discussed earlier, and the HTML page that embeds the magazine's Flash file contains this agent ID, as shown in the underlined text below.

<object classid=“clsid:d27cdb6e-ae6d-11cf-96b8-444553540000”
codebase=“http://fpdownload.macromedia.com/pub/shockwave/cabs/flash/
swflash.cab#version=8,0,0,0” width=“100%” height=“100%” id=“fm”
align=“middle”>
<param name=“allowScriptAccess” value=“sameDomain” />
<param name=“movie” value=“http://s3.amazonaws.com/
honeymoon_staging/magazine_issue_files/29/hm_issue1.swf” />
<param name=“quality” value=“best” />
<param name=“wmode” value=“transparent” />
<param name=“bgcolor” value=“#ffffff” />
<param name=“FlashVars” value=“pageNumber=0&pid=9132180” />
<embed src=“http://s3.amazonaws.com/honeymoon_staging/
magazine_issue_files/29/hm_issue1.swf” quality=“best”
wmode=“transparent” bgcolor=“#ffffff”
width=“100%” height=“100%” name=“fm” align=“middle”
allowScriptAccess=“sameDomain” type=“application/x-shockwave- flash”
pluginspage=“http://www.macromedia.com/go/getflashplayer”
FlashVars=“pageNumber=0&pid=9132180”
/>
</object>

The magazine's Flash file is opened, and the Flash file reads the value of the agent ID. To get the details that it needs regarding this agent, the Flash file requests an XML file from the server or other computer on which the Content Management System resides, and which contains the agent's details. In this example, the Flash file would request the following resource:

http://www.thehoneymoon.com/partners/9132180.xml

The server then generates and returns an XML file to the Flash file. The XML file for this example is shown below:

<?xml version=“1.0” encoding=“UTF-8”?>
<partner>
<company-info>
<logo>/images/partner_logos/0000/1501/ctae_normal. jpg</logo>
<name>Carrousel Travel / American Express</name>
<about-us></about-us>
<booking-url></booking-url>
<created-at>11/16/2001 00:00</created-at>
<email>carol@carrouseltravel.com</email>
<iata></iata>
<id>9132180</id>
<profile-intro>...</profile-intro>
<profile-published>true</profile-published>
<specialties>...</specialties>
<updated-at>05/30/2008 00:31</updated-at>
<url>http://www.carrouseltravel.com</url>
</company-info>
<primary_contact>
<full-name>Neal Kraemer</full-name>
<email>nealk@charter.net</email>
</primary_contact>
<mailing-address>
<address-1>6625 Lyndale Ave. S</address-1>
<address-2></address-2>
<city>Minneapolis</city>
<state-or-province>MN</state-or-province>
<postal-code>55423</postal-code>
</mailing-address>
<local-phone>(612) 866-2503</local-phone>
<toll-free-phone>(800) 800-6508</toll-free-phone>
</partner>

The Flash file parses this XML document, pulls out the information that it needs to customize the publication with the agent's information, and modifies its output (the customized publication) accordingly.

It should be noted that the XML itself is not stored anywhere, nor is it pre-generated. If the distributor/agent changes its profile information, those changes will automatically appear in the customized publication. It should also be understood that although Flash (multimedia platform) and XML (markup language) are the file types currently used for implementation of the inventive process, the inventive process can use any file types or formats that are suitable to implement the process—in other words, the file types and formats are not limited to Flash and XML examples described herein.

Thus, the publication that is delivered to the prospect, client, or associate in custom publication delivery step 80 contains the distributor/agent's promotional advertisement, which is placed on a pre-designated page.

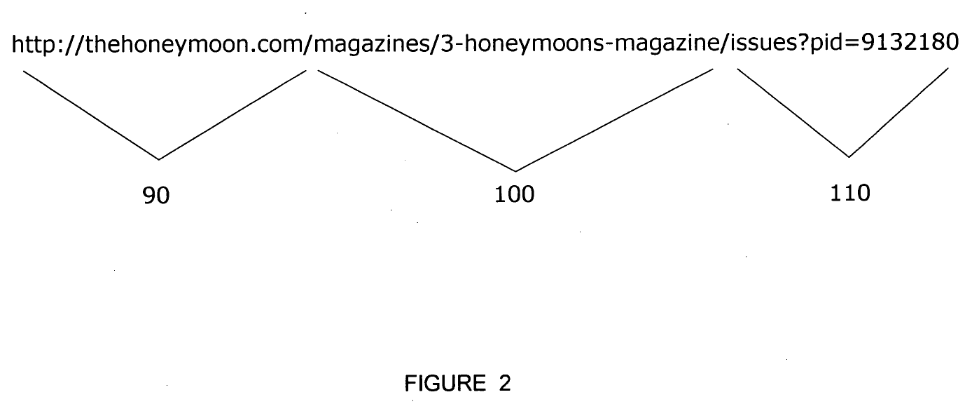

FIG. 2 shows an example custom URL that is generated by the Content Management System, and identifies the components of the custom URL. Specifically, “http://thehoneymoon.com” is the domain component 90 of the custom URL, and this component identifies the domain and thus the server or other computer on which the Content Management System resides. Next, “/magazines/3-honeymoons-magazine” is the publication component of the custom URL, and this component tells the server which version of the publication to provide to the prospect or client that clicks on the custom URL. Finally, “/issues?pid=9132180” is the distributor/agent component 110 of the custom URL, and this component tells the server which distributor/agent should receive credit for the distribution and which distributor/agent's identity and other information should be dynamically inserted into the custom publication.

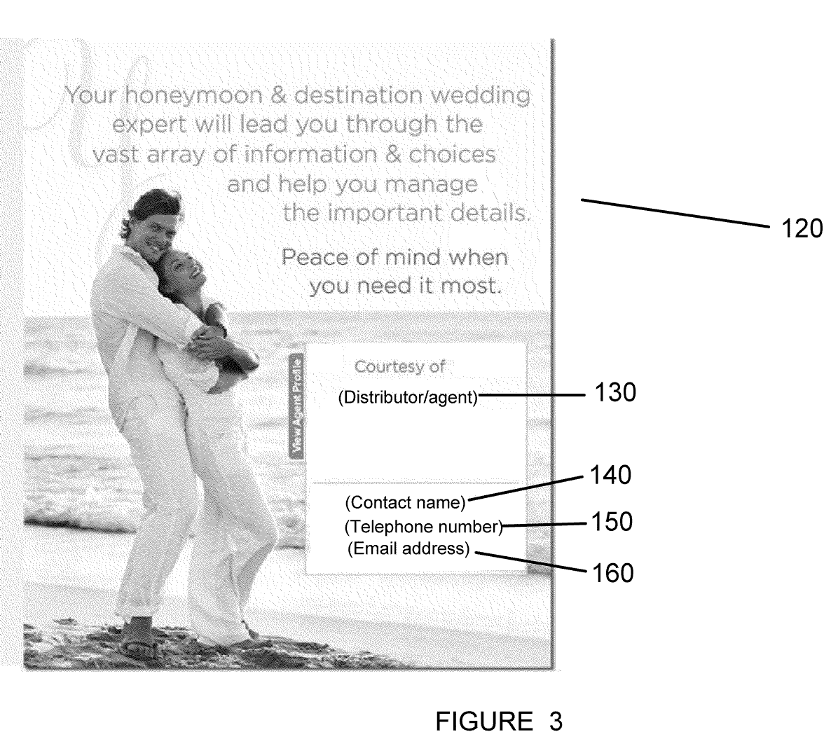

FIG. 3 shows a digital publication template 120 that can be customized with distributor/agent information. In this template, the customizable fields are the distributor/agent field 130, which would be customized with the name, company name, etc. of the agent; the contact name field 140, which would be customized with the name of a particular individual to contact for further information; the telephone number field 150, which would be customized with the telephone number of the agent; and the email address field 160, which would be customized with the email address of the agent.

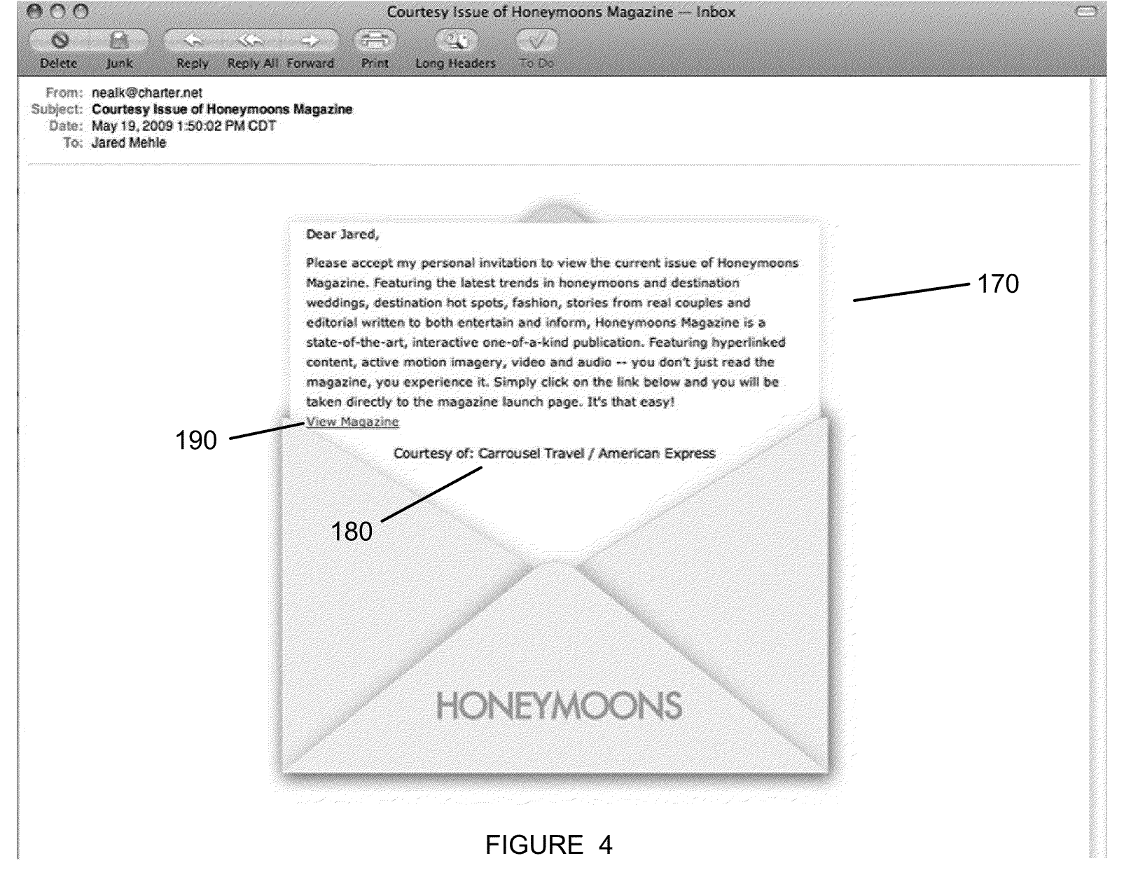

FIG. 4 shows an email 170 sent by the distributor/agent to the prospect or client. Email 170 contains text explaining the invitation to view the digital publication, as well as a customized email field 180 that contains the name or company name of the agent who distributed the email. Email 170 also contains a view magazine link 190, and underlying this link is the custom URL generated earlier.

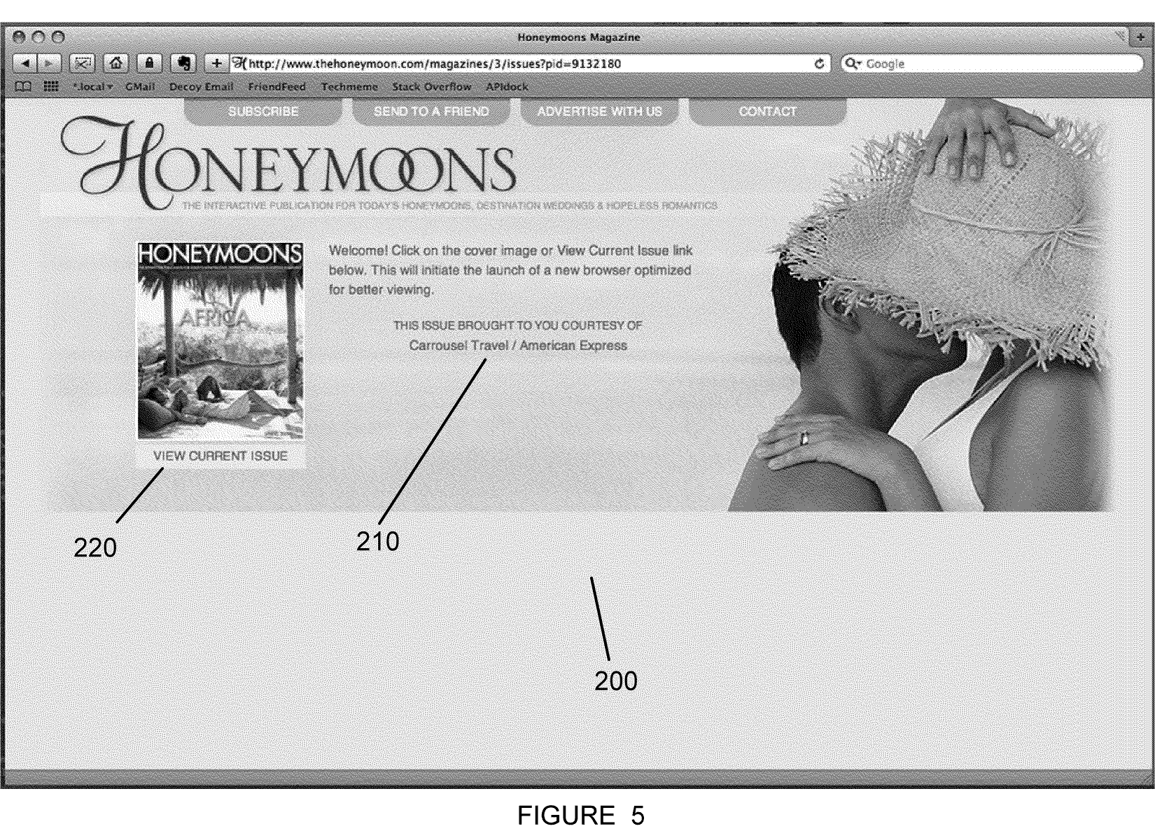

When the prospect or client clicks on view magazine link 190, he/she is taken to the publication launch webpage 200 shown in FIG. 5. Publication launch webpage 200 contains text further instructing the prospect or client on how to view the digital publication, as well as a customized launch webpage field 210 that contains the name or company name of the agent who is distributing the publication. Publication launch webpage 200 also contains a view current issue link 220.

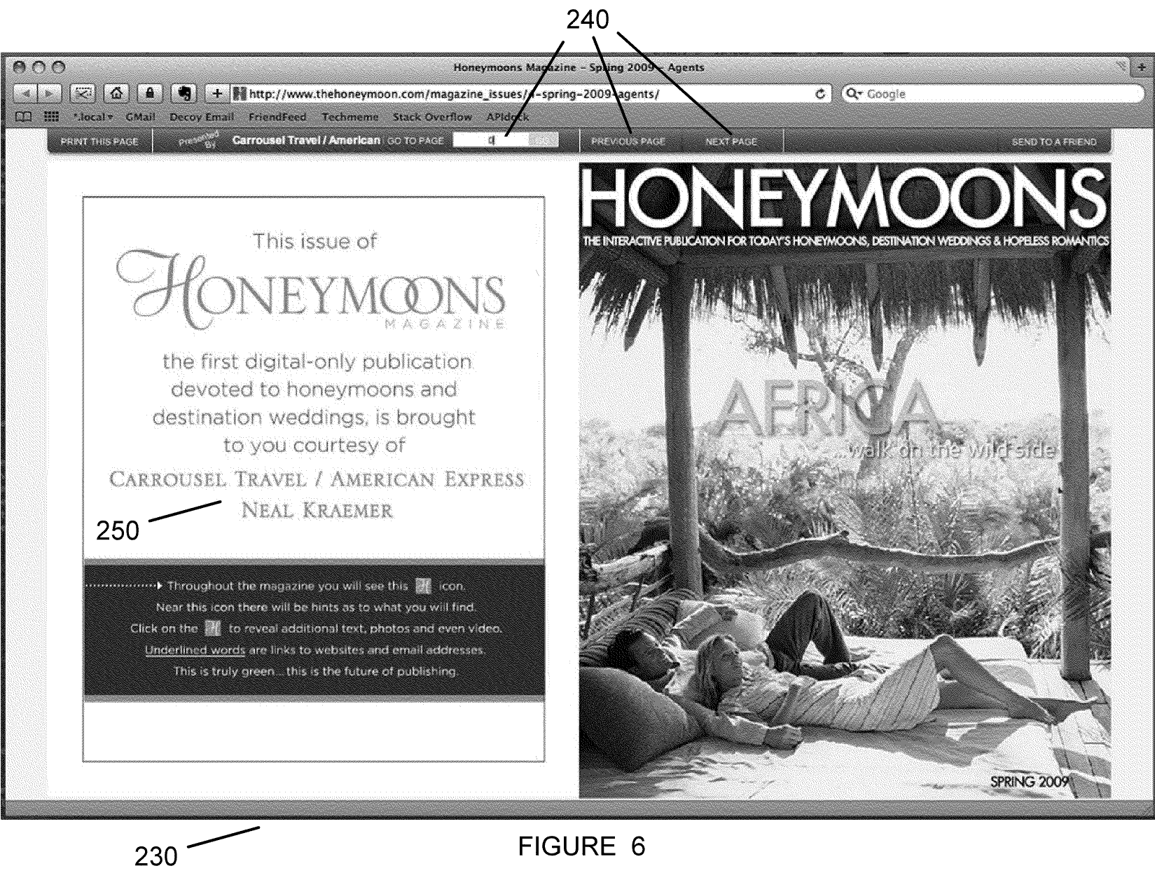

When the prospect or client clicks on view current issue link 220, he/she is taken to the publication cover page 230 shown in FIG. 6. Publication cover page 230 is the “front page” of the customized publication, and it contains information on how to navigate through the publication as well several page selection tools 240 located on a toolbar on the page. Using page selection tools 240, the prospect or client can page through the customized publication. Publication cover page 230 also contains a customized cover page field showing the name or company name of the agent who is distributing the publication.

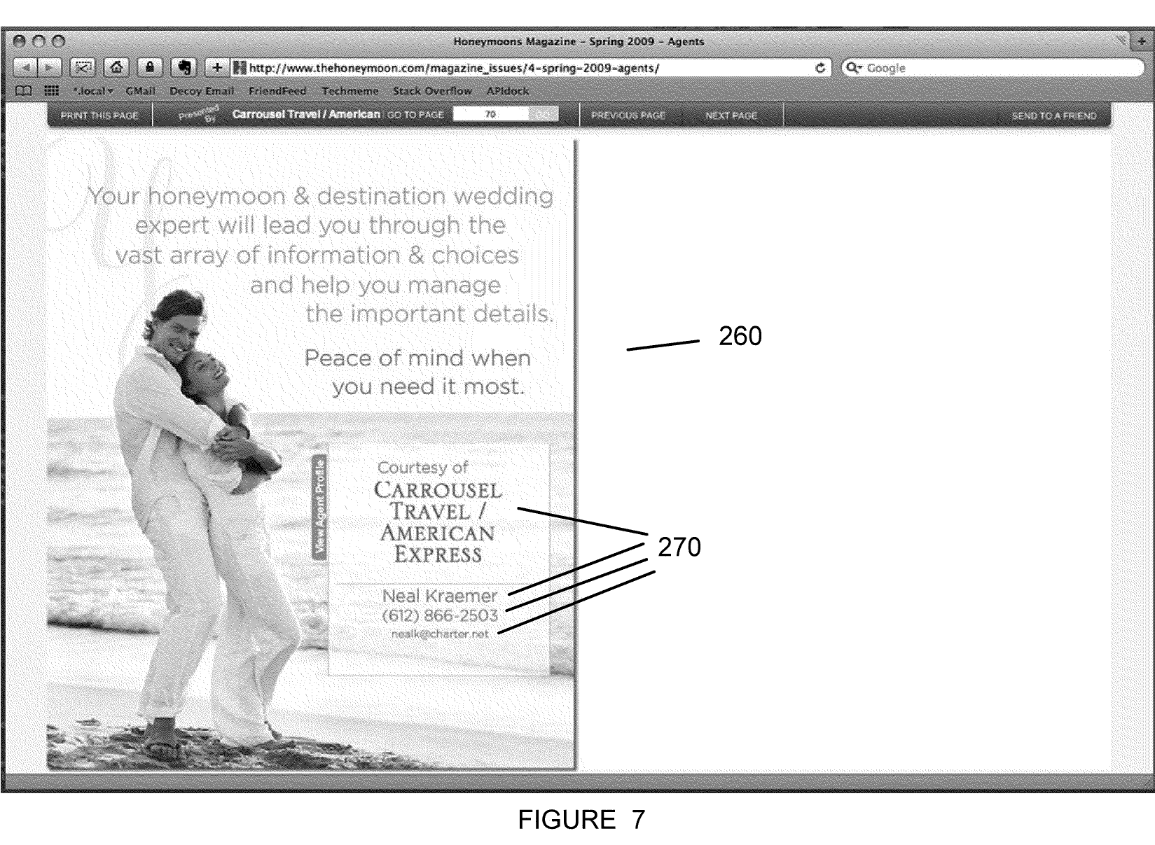

FIG. 7 shows another customized page within the publication, specifically an advertisement 260 corresponding to the publication template shown in FIG. 3. Advertisement 260 contains the advertisement itself as well as customized advertisement fields 270 showing the name or company name of the agent who is distributing the publication, and other contact information for the agent.

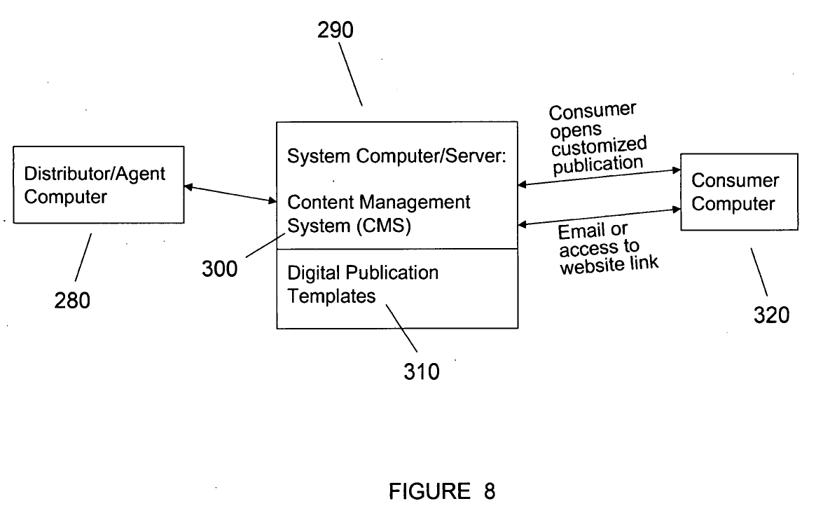

FIG. 8 is a diagram illustrating the various system components present in the invention, through which the inventive process is carried out. The system comprises a distributor/agent computer 280, which the distributor/agent uses to log into a system computer/server 290. System computer/server 290 contains the software necessary to run the inventive process, including the content management system 300. Digital publication templates 310 are either contained on system computer/server 290, or are contained on a separate computer and uploaded to system computer/server 290 as needed. The system also comprises a consumer computer 320, which the consumer (the prospect, client, or associate of the distributor/agent) uses to receive the email containing the custom URL or to access a website link containing the custom URL. The consumer also uses consumer computer 320 to open and view the customized digital publication. It should be understood that distributor/agent computer 280, system computer/server 290, and consumer computer 320 communicate with each other over any suitable network, including but not limited to the Internet.

Conclusions, Ramifications, and Scope:

Thus the reader will see that the process and system of the invention is a very advantageous way to increase the distribution of digital publications, by giving agents of the publication owner an incentive to distribute the digital publication to their prospects, clients, or associates.

While the above descriptions contain many specificities, these shall not be construed as limitations on the scope of the invention, but rather as exemplifications of embodiments thereof. Many other variations are possible without departing from the spirit of the invention. Non-limiting examples of just a few of the possible variations follow:

The digital publication can be further customized for the benefit of the distributor, in addition to the customization discussed above and shown in the drawings. For example, in addition to customized advertisements, the publication could have articles that include a generic reference to the agent, in which case the distributing agent could have his/her name substituted into the article. Said another way, the article would be customized by inserting the distributing agent's name or other information where appropriate into the article. This would increase the agent's status in a competitive market.

In addition to the distributor/agent, the prospects, clients, or associates of that distributor/agent who receive the custom URL (e.g., consumers) may also play an incentive-based role in distributing the digital publication.

It should be understood that a digital publication template of the invention can have more or fewer customizable fields than those shown in FIG. 3, and that the customizable fields can be differently sized or located on the page.

Accordingly, the scope of the invention should be determined not by the embodiments illustrated, but by the appended claims and their legal equivalents.

What is claimed is:

1. A method for distributing a digital publication, comprising the steps of:
(a) selecting, by a distributor for the digital publication owner, at least one customizable digital publication;
(b) generating a custom uniform resource locator that includes a portion identifying said distributor and a portion identifying said at least one customizable digital publication;
(c) sending said custom uniform resource locator to a prospect, client, or associate of said distributor;
(d) inserting information about said distributor into said at least one customizable digital publication when said prospect, client, or associate accesses said custom uniform resource locator; and
(e) presenting said at least one customizable digital publication, customized with the information about said distributor, to said prospect, client or associate.

2. The method of claim 1, wherein said at least one customizable digital publication contains a publication cover page customized with the information about said distributor.

3. The method of claim 1, wherein said at least one customizable digital publication contains at least one advertisement customized with the information about said distributor.

4. The method of claim 1, wherein the information about said distributor comprises the distributor's name, postal address, telephone number, or email address.

5. The method of claim 1, wherein said selecting step includes selecting from a list containing a plurality of customizable digital publications that said distributor can distribute.

6. The method of claim 1, wherein said sending step includes sending said custom uniform resource locator by email.

7. The method of claim 1, wherein said sending step includes sending said custom uniform resource locator in the form of a link located on a webpage.

8. The method of claim 1, wherein said distributor initiates the sending of said custom uniform resource locator to said prospect, client, or associate of said distributor.

9. The method of claim 1, wherein said presenting step includes presenting a publication launch webpage from which said prospect, client, or associate can access said at least one customizable digital publication, customized with the information about said distributor.

10. The method of claim 1, wherein said inserting step includes inserting the information about said distributor based on the portion of the uniform resource locater identifying said distributor.

11. A system for distributing a digital publication, comprising:
(a) a system computer capable of communicating with an distributor computer used by a distributor for the digital publication owner, said system computer having means for selecting, by said distributor, at least one customizable digital publication;
(b) said system computer having means for generating a custom uniform resource locator that includes a portion identifying said distributor and a portion identifying said at least one customizable digital publication, and having means for sending said custom uniform resource locator to a consumer computer used by a prospect, client, or associate of said distributor;
(c) said system computer having means for inserting information about said distributor into said at least one customizable digital publication when said prospect, client, or associate accesses said custom uniform resource locator; and having means for presenting said at least one customizable digital publication, customized with the information about said distributor, to said prospect, client, or associate.

12. The system of claim 11, wherein said at least one customizable digital publication contains a publication cover page customized with the information about said distributor.

13. The system of claim 11, wherein said at least one customizable digital publication contains at least one advertisement customized with the information about said distributor.

14. The system of claim 11, wherein the information about said distributor comprises the distributor's name, postal address, telephone number, or email address.

15. The system of claim 11, wherein said means for selecting includes means for selecting from a list containing a plurality of customizable digital publications that said distributor can distribute.

16. The system of claim 11, wherein said means for sending includes means for sending said custom uniform resource locator by email.

17. The system of claim 11, wherein said means for sending includes means for sending said custom uniform resource locator in the form of a link located on a webpage.

18. The system of claim 11, wherein said distributor initiates the sending of said custom uniform resource locator to said prospect, client, or associate of said distributor.

19. The system of claim 11, wherein said means for presenting includes means for presenting a publication launch webpage from which said prospect, client, or associate can access said at least one customizable digital publication, customized with the information about said distributor.

20. The system of claim 11, wherein said means for inserting includes means for inserting the information about said distributor based on the portion of the uniform resource locater identifying said distributor.
